(19) United States
(12) Patent Application Publication
(10) Pub. No.: US 2010/0063841 A1
(43) Pub. Date: Mar. 11, 2010

(54) SYSTEM AND METHOD OF NOTIFYING DESIGNATED ENTITIES OF ACCESS TO PERSONAL MEDICAL RECORDS

(75) Inventors: Robert Matthew D'Ambrosia, Corona Del Mar, CA (US); Edward A. Sicard, Newport Beach, CA (US); Frank Zanka, Long Beach, CA (US)

Correspondence Address: FOUNTAIN LAW GROUP, INC., 18201 VON KARMAN AVENUE, SUITE 960, IRVINE, CA, 92612, US

(73) Assignee: VITAL DATA TECHNOLOGY, LLC, Newport Beach, CA (US)

(21) Appl. No.: 12/205,660

(22) Filed: Sep. 5, 2008

(51) Int. Cl. G06F 19/00; G06Q 50/00; G06F 7/04

(52) U.S. Cl. 705/3; 705/2; 726/4

(57) ABSTRACT

A medical information server and corresponding methods are disclosed for processing of personal medical information, providing some or all of the medical information to authorized requesting entities, and providing notifications of access to personal medical records to designated entities. The server may receive a request for personal medical record information from a communications device of a requesting entity; authenticate and authorize the request; send the requested information to the authorized requesting entity; and send notification of the access to one or more designated entities. The server may further update an access history pertaining to the personal medical record to note the access. The server may further receive a request for the access history of a personal medical record, and send the requested access history information to the authorized requesting entity. Additionally, the server may send notification of the access to the history to one or more designated entities.

### FIELD OF THE INVENTION

This invention relates generally to medical information management systems, and in particular, to a system and method of notifying one or more designated entities of access to a personal medical record.

### BACKGROUND OF THE INVENTION

Many databases have been created that hold personal medical records for access by authorized health-related entities. Typically, some these databases serve special purposes, such as providing personal medical record information to first responders or other health care providers during emergency situations. Examples of such databases have been described in pending patent applications entitled “System and Method for Aggregating and Providing Subscriber Medical Information to Medical Units,” Ser. No. 11/223,653, filed on Sep. 8, 2005 and “System and Method of Aggregating and Disseminating In-Case-of-Emergency Medical and Personal Information,” Ser. No. 11/734,776, filed on Apr. 12, 2007, which are both incorporated herein by reference.

In such systems, a subscriber provides consent to the entity operating the database to store and disseminate his/her medical record information to authorized health-related entities during emergency or other situations. The subscriber completes an electronic medical form, or an electronic medical record is created by an electronic data integration (EDI) interface, which serves to create the medical record in the database. The subscriber is also provided an access code, which may be electronically coded on a magnetic card, bracelet, or other item worn or carried by the subscriber. When the subscriber is involved in a medical emergency situation, a first responder attending to the subscriber obtains his/her access code and uses it to access the subscriber medical record information from the database. The first responder uses the information in medically treating the patient.

The dissemination of individual medical record information generally triggers concern regarding privacy. In the U.S., Congress enacted the Health Insurance Portability and Accountability Act (HIPPA) which prescribes regulations for the use and disclosure of protected health information. A purpose of HIPPA is to protect individual health information so that the public feels confident in disclosing personal health information and knowing that there are safeguards in place for the protection of the information.

Even with such safeguards in place, the security of the information is still not flawless. Unscrupulous people may gain access to subscribers access codes or otherwise gain unauthorized access to their medical record information. Additionally, even entities that are authorized to access subscribers medical records may misuse the information or not guard it successfully. If subscribers or other designated entities were to be notified of who is accessing their respective medical records, they may police the access and ultimately better protect the information. The notification of access to subscribers medical records may have additional applications beyond the protection of information.

### SUMMARY OF THE INVENTION

An aspect of the invention relates to a medical information server adapted to receive a request for information pertaining to a personal medical record from a first communications device operated by a first entity; send the requested information to the first communications device; and send a notification of access to the personal medical record by the first entity to a second communications device operated by a second entity. The second entity receiving the notification of the access may be the person to which the medical record pertains. In another aspect, the medical information server is further adapted to authenticate and authorize the request for the information. In yet another aspect, the medical information server is further adapted to update an access history pertaining to the personal medical record to note the access to the medical record by the first entity.

In another aspect, the medical information server is adapted to receive a request for information pertaining to an access history of a personal medical record from a communications device, and send the requested access history information to the communications device of the requesting entity. In yet another aspect, the medical information server is adapted to send a notification of the access to the access history information to another communications device. In still another aspect, the medical information server is adapted to authenticate and authorize the request for the access history information.

In still other aspects, the information related to the personal medical record may include one or more of the following: personal and demographic information, in-case-of-emergency information, medical insurance and primary care information, and health information. In yet another aspect, the information pertaining to an access history of a personal medical record may include one or more of the following: information related to an identity of the requesting entity (e.g., person, place, or combination thereof), information related to a date of access to the access history, information related to a time of access to the access history, and information related to a reason for access to the access history.

In another aspect, the entity requesting the personal medical record information may be a health care provider that is medically treating or about to treat the person to which the medical record pertains. In yet another aspect, the entity being provided the notification of the access may be the person to which the medical record pertains, one or more emergency contact persons designated by the person to which the medical record pertains, the person's health insurer, a disease management provider, a government health agency and/or plan, emergency response agency, etc.

Another aspect relates to a method of determining abuse of emergency room (ER) visits, comprising sending a request for information pertaining to a medical record of a patient seeking medical treatment to a medical record server by way of a communications network; receiving the requested information by way of the communications network, wherein information includes data related to visits to ER made by the patient; and examining the information to determine whether the patient has abused ER visits. In another aspect, the method further comprises reporting the abuse to another entity if abuse of ER visits has been determined. In still another aspect, the method further comprises denying medical treatment to the patient if abuse of ER visits has been determined.

Other aspects, advantages and novel features of the present invention will become apparent from the following detailed description of the invention when considered in conjunction with the accompanying drawings.

### BRIEF DESCRIPTION OF THE DRAWINGS

FIG. 1 illustrates a block diagram of an exemplary communications system in accordance with an embodiment of the invention.

FIG. 2 illustrates a flow diagram of an exemplary method of notifying one or more designated entities of access to a personal medical record in accordance with another embodiment of the invention.

FIG. 3 illustrates an exemplary data structure for a personal medical record in accordance with another embodiment of the invention.

FIG. 4A illustrates a block diagram of another exemplary communications system in accordance with another embodiment of the invention.

FIG. 4B illustrates a flow diagram of an exemplary method of processing a request for an access history of a personal medical record in accordance with another embodiment of the invention.

FIG. 5A illustrates a block diagram of another exemplary communications system in accordance with another embodiment of the invention.

FIG. 5B illustrates a flow diagram of an exemplary method of processing a request for a personal medical record made by a health care provider, and notifying a health insurer of the access in accordance with another embodiment of the invention.

FIG. 6A illustrates a block diagram of another exemplary communications system in accordance with another embodiment of the invention.

FIG. 6B illustrates a flow diagram of an exemplary method of processing a request for a personal medical record made by a health care provider, and notifying a disease management provider of the access in accordance with another embodiment of the invention.

FIG. 7A illustrates a block diagram of another exemplary communications system in accordance with another embodiment of the invention.

FIG. 7B illustrates a flow diagram of an exemplary method of processing a request for a personal medical record made by a health care provider, and notifying a government health plan of the access in accordance with another embodiment of the invention.

FIG. 8A illustrates a block diagram of another exemplary communications system in accordance with another embodiment of the invention.

FIG. 8B illustrates a flow diagram of an exemplary method of processing automatic requests for personal medical records, and notifying designated entities in accordance with another embodiment of the invention.

FIG. 9A illustrates a block diagram of an exemplary medical information server with a network interface in accordance with another embodiment of the invention.

FIG. 9B illustrates a flow diagram of an exemplary method of notifying one or more designated entities of access to a personal medical record performed by the medical information server in accordance with another embodiment of the invention.

FIG. 9C illustrates a flow diagram of an exemplary method of processing a request for an access history of a personal medical record performed by the medical information server in accordance with another embodiment of the invention.

FIG. 10 illustrates a flow diagram of a method of monitoring the frequency of emergency room (ER) visits by patients in accordance with another embodiment of the invention.

### DETAILED DESCRIPTION OF THE EXEMPLARY EMBODIMENTS

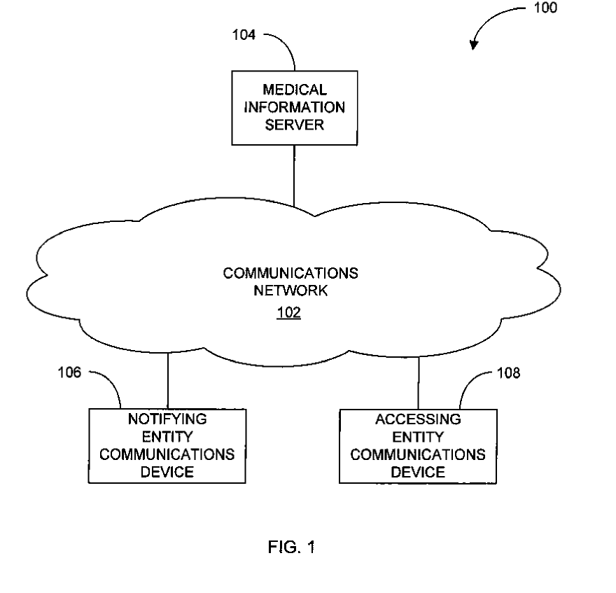

FIG. 1 illustrates a block diagram of an exemplary communications system 100 in accordance with an embodiment of the invention. In summary, the communications system 100 comprises a medical information server that stores a plurality of personal medical records, provides personal medical records information to authorized requesting entities, and provides notification of access to personal medical records to designated entities. As alluded to in the Background section, there are many benefits and applications associated with providing notification of access to personal medical records, such as enhanced protection of the information, automatic notification to emergency contacts, entity reunification, better patient care management, improved management of public health plans and policy, and others.

In particular, the communications system 100 comprises a communications network 102, a medical information server 104, a notifying entity communications device 106, and an access entity communications device 108. The communications network 102 may be any type of network that facilitates the communication of digital information between various entities. For example, the communications network 102 may include a local area network (LAN), a wide area network (WAN), such as the Internet, a private network, a cellular telephone network, any combination thereof, and others. The communications network 102 may communicate digital information using any of a number of protocols, such as Internet Protocol (IP), Asynchronous Transfer Mode (ATM), wireless protocols such as WiFi, Bluetooth, IEEE 802.11, any combination thereof, and others.

The medical information server 104 is communicatively coupled to the communications network 102, and includes a database comprising a plurality of personal medical records and a list of authorized entities for access of the records. The medical information server 104 performs at least three function: First, the medical information server 104 maintains the personals medical records, such as by creating personal medical records upon request, updating personal medical records upon request, and deleting personal medical records upon request. Second, the medical information server 104 provides personal medical record information to authorized requesting entities via the communications network 102. Third, the medical information server 104 provides notification of access to personal medical records to designated entities via the communications network 102. The medical information server 104 may be any device that is capable of communicating with any other device via the communications network 102.

The notifying entity communications device 106 is communicatively coupled to the communications network 102. As discussed in more detail further herein, the notifying entity communications device 106 is an example of an entity designated to receive notification of access to a personal medical record. The accessing entity communications network 108 is communicatively coupled to the communications network 102. As discussed in more detail further herein, the accessing entity communications device 108 is an example of an authorized entity requesting and receiving a personal medical record information from the medical information server 104. The notifying and accessing entity communications devices 106 and 108 may be any device that is capable of communicating with any other device via the communications network 102.

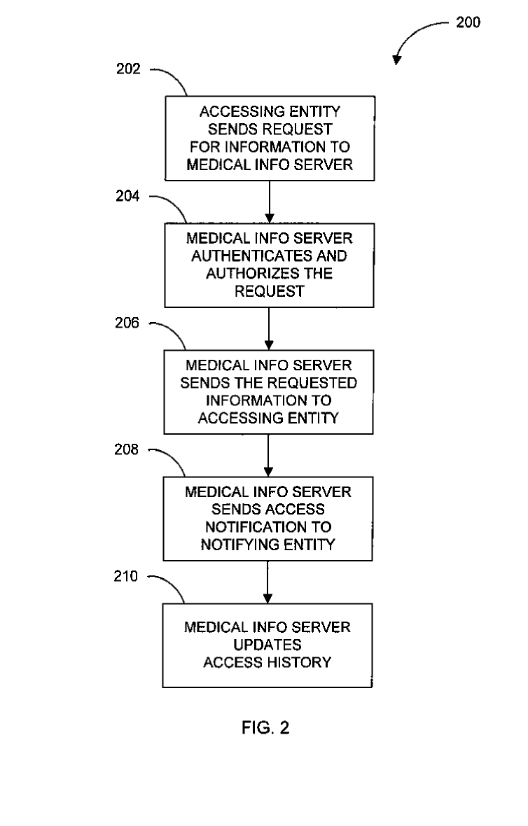

FIG. 2 illustrates a flow diagram of an exemplary method 200 of notifying one or more designated entities of access to a personal medical record in accordance with another embodiment of the invention. With reference to also FIG. 1, according to the method 200, the accessing entity communications device 108 sends a request for information pertaining to a personal medical record to the medical information server 104 by way of the communications network 102 (block 202). Typically, the request will include information related to the identity of the requesting entity, such as an authorization code (e.g., username, password, IP address, etc.). In response to receiving the request, the medical information server 104 authenticates and authorizes the request (block 204). This is done to ensure that the requesting entity is authorized to receive the requested information.

Once the medical information server 104 authenticates and authorizes the request, the server 104 accesses the personal medical record information from a local or remote database, and sends the requested information to the accessing entity communications device 108 by way of the communications network 102 (block 206). Additionally, the medical information server 104 also determines the identity of the designated notifying entity by examining the personal medical record, and then sends a notification of the access to the personal medical record by the accessing entity to the notifying entity communications device 106 by way of the communications network 102 (block 208). The notification may be sent via a number of communications protocols, such as email, short message service (SMS), multimedia messaging service (MMS), automated voice response, system integrated message, asynchronous messaging, and others.

The medical information server 104 also updates an access history of the personal medical record to note the accessing of the information by the accessing entity. The update to the access history may include information related to the accessing of the information, such as the identity of the accessing entity (e.g., person or company name, contact information, etc.), date of access, time of access, reason for access (e.g., emergency room (ER) visit), location of access (e.g., communication device type), etc. Although the operations of the method 200 are described with a particular order, it shall be understood that the method may be implemented in any order to achieve substantially the same results. If the notifying entity is the person to which the medical record pertains (or a relative, friend, or other designated party), he or she may be able to monitor the accessing of the information for the purpose of detecting unauthorized access or misuse of the information.

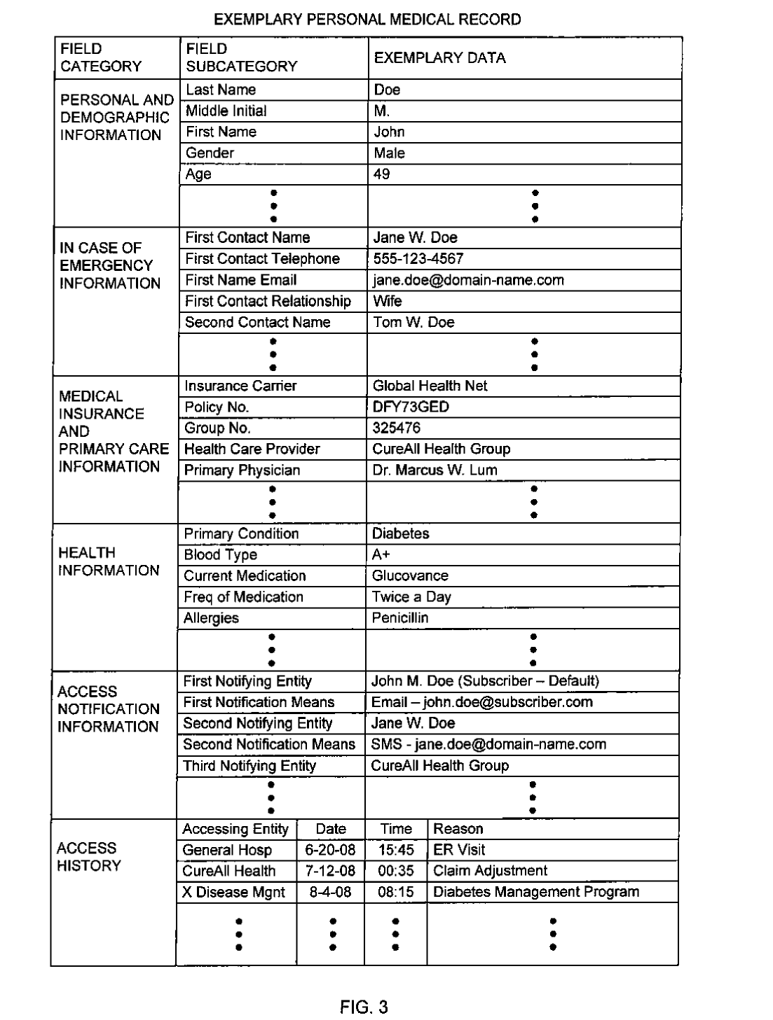

FIG. 3 illustrates an exemplary data structure for a personal medical record in accordance with another embodiment of the invention. The personal medical record information may be organized into several field categories. For example, such field categories may include personal and demographic information, in-case-of-emergency information, medical insurance and primary care information, personal health information, access notification information, and access history information.

Under each of the field categories, there may be several subcategories or fields. For example, under the personal and demographic category, the subcategories or fields may include person's last name (e.g., Doe), middle initial (e.g., M.), first name (e.g., John), gender (e.g., Male), age (e.g., 49), and others. Under the in-case-of-emergency category, the subcategories or fields may include first contact name (e.g., Jane W. Doe), first contact telephone (e.g., 555-123-4567), first contact email (e.g., jane.doe@domain-name.com), first contact relationship (e.g., Wife), second contact name (e.g., Tom W. Doe), and others.

Under the medical insurance and primary care category, the subcategories or fields may include insurance carrier (e.g., Global Health Net), policy no. (e.g., DFY73GED), group no. (e.g., 325476), health care provider (e.g., CureAll Health Group), primary physician (e.g., Dr. Marcus W. Lum), and others. Under the personal health information category, the subcategories or fields may include primary condition (e.g., Diabetes), blood type (e.g., A+), current medication (e.g., Glucovance), frequency (e.g., Twice a Day), allergies (e.g., Penicillin) and others.

Under the access notification category, the subcategories or fields may include first notifying entity (e.g., John M. Doe (Default)), first notification means (e.g., Email—john.doe@subscriber.com), second notifying entity (e.g., Jane W. Doe), second notification means (e.g., SMS—jane.doe@domain-name.com), third notifying entity (e.g., CureAll Health Group), and others. Under the access history category, the subcategories or fields may include accessing entity, date of access, time of access, reason for access (e.g., General Hospital, June 20, 2008, 3:45 PM, and ER Visit, etc.), and others.

With respect to the method 200 previously described, the medical information server 104 sends some or all of the information within the personal and demographic, in-case-of-emergency, medical insurance and primary care, and personal health categories to the authorized accessing entity per block 206. Also, the medical information server 104 sends notification of the access to the one or more entities identified in the access notification category per block 208. Additionally, the medical information server 104 updates the access history category with information regarding the access per block 210.

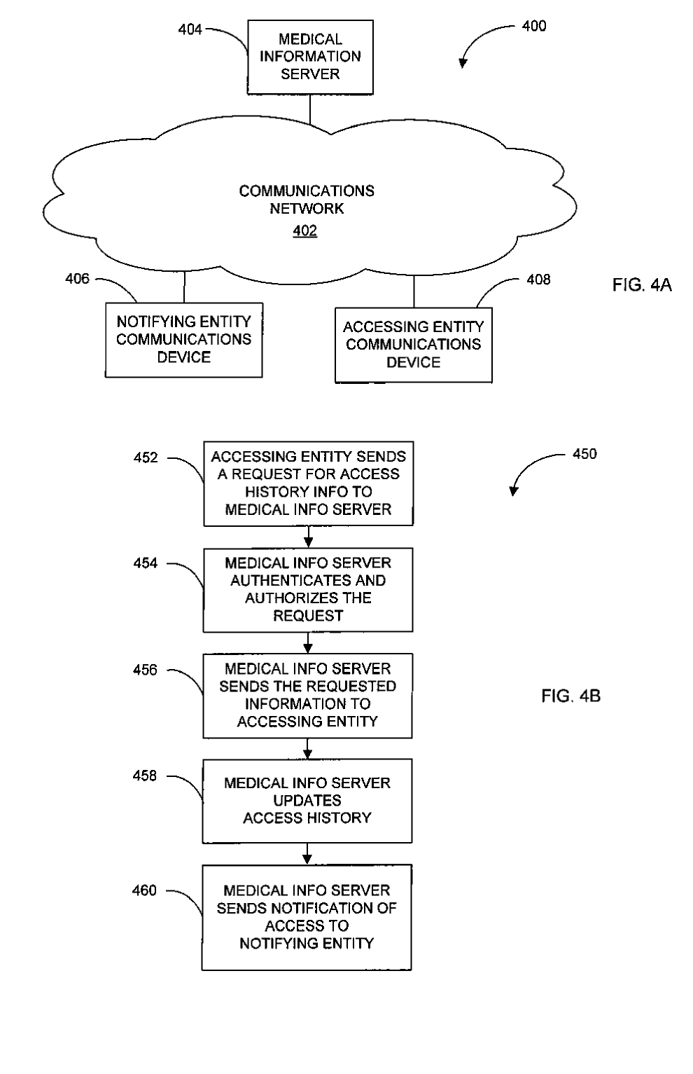

FIG. 4A illustrates a block diagram of another exemplary communications system 400 in accordance with another embodiment of the invention. The communications system 400 comprises a communications network 402, a medical information server 404 coupled to the communications network 402, a notifying entity communications device 406 coupled to the communications network 402, and an accessing entity communications device 408 coupled to the communications network 402. The communications system 400 may be configured substantially the same or similar to communications system 100. As discussed below, the communications system 400 is configured for processing requests for access history information of personal medical records.

FIG. 4B illustrates a flow diagram of an exemplary method 450 of processing a request for an access history of a personal medical record in accordance with another embodiment of the invention. According to the method 450, the accessing entity communications device 408 sends a request for the access history information of a particular personal medical record to the medical information server 404 via the communications network 402 (block 452). In response to the request, the medical information server 404 authenticates and authorizes the request (block 454).

Once the request has been authenticated and authorized, the medical information server 404 sends the requested access history information to the accessing entity communications device 408 via the communications network 402 (block 456). Additionally, the medical information server 404 updates the access history (block 458), and sends a notification of the access to the notifying entity communications device 406 via the communications network 402 (block 460). In this example, the notifying entity communications device 406 has been identified in the personal medical record as an entity that is to receive notifications of access to the medical record. Although the operations of the method 450 are described with a particular order, it shall be understood that the method may be implemented in any order to achieve substantially the same results.

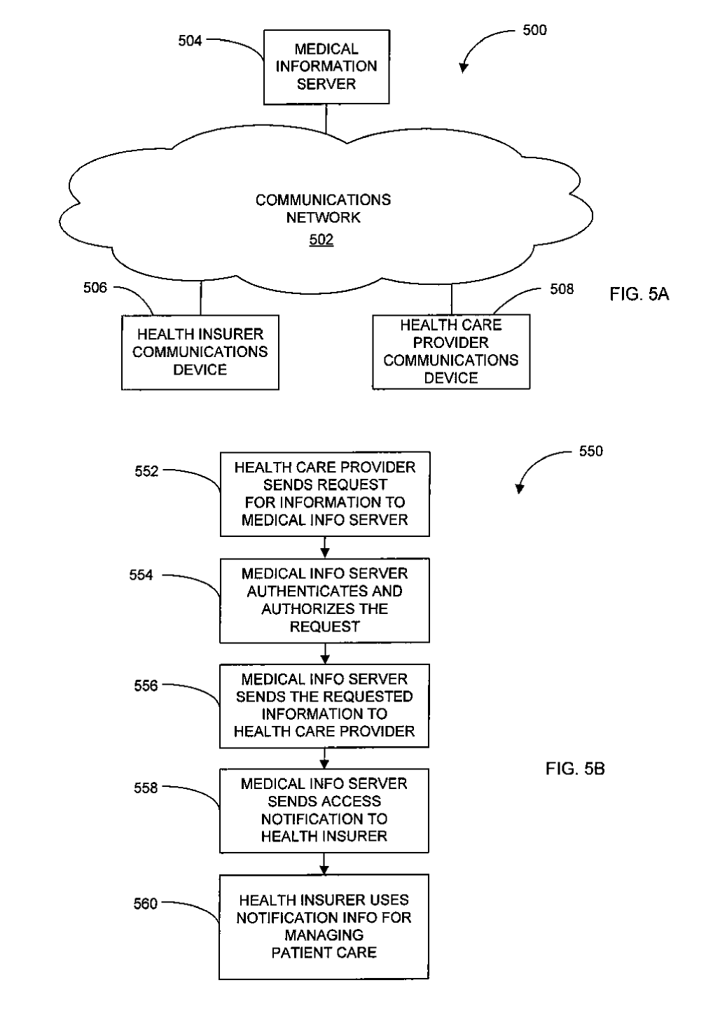

FIG. 5A illustrates a block diagram of another exemplary communications system 500 in accordance with another embodiment of the invention. The communications system 500 comprises a communications network 502, a medical information server 504 coupled to the communications network 502, a health insurer communications device 506 coupled to the communications network 502, and a health care provider communications device 508 coupled to the communications network 502. The communications system 500 may be configured substantially the same or similar to communications system 100. The communications system 500 is used herein to illustrate an exemplary application of the medical record access notification concepts described herein.

FIG. 5B illustrates a flow diagram of an exemplary method 550 of processing a request for a personal medical record made by a health care provider, and notifying a health insurer of the access in accordance with another embodiment of the invention. According to the method 550, the health care provider communications device 508 sends a request for information pertaining to a particular personal medical record to the medical information server 504 via the communications network 502 (block 552). This may be the case where the health care provider is medically treating or about to treat the person to which the medical record pertains, and requires information about the person to better perform the patient care.

In response to the request, the medical information server 504 authenticates and authorizes the request (block 554). This is to ensure that the health care provider is authorized to gain access to the requested personal medical record. Once the request has been authenticated and authorized, the medical information server 504 sends the requested information to the health care provider communications device 508 via the communications network 502 (block 556). The health care provider uses the information to better provide patient care to the patient and/or for other purposes.

Additionally, the medical information server 504 sends a notification of the access to the personal medical record by the health care provider to the health insurer communications device 506 via the communications network 502 (block 558). In this example, the health insurer is identified in the personal medical record as an entity that is to receive notifications of access to the medical record. The health insurer then uses the notification information for performing better patient care management and/or for other purposes (block 560). For example, the health insurer may use the information to provide better disease management programs, claims management, suggest physicians or specialists, suggest follow-up procedures, suggest alternative drugs, etc. Although the operations of the method 550 are described with a particular order, it shall be understood that the method may be implemented in any order to achieve substantially the same results.

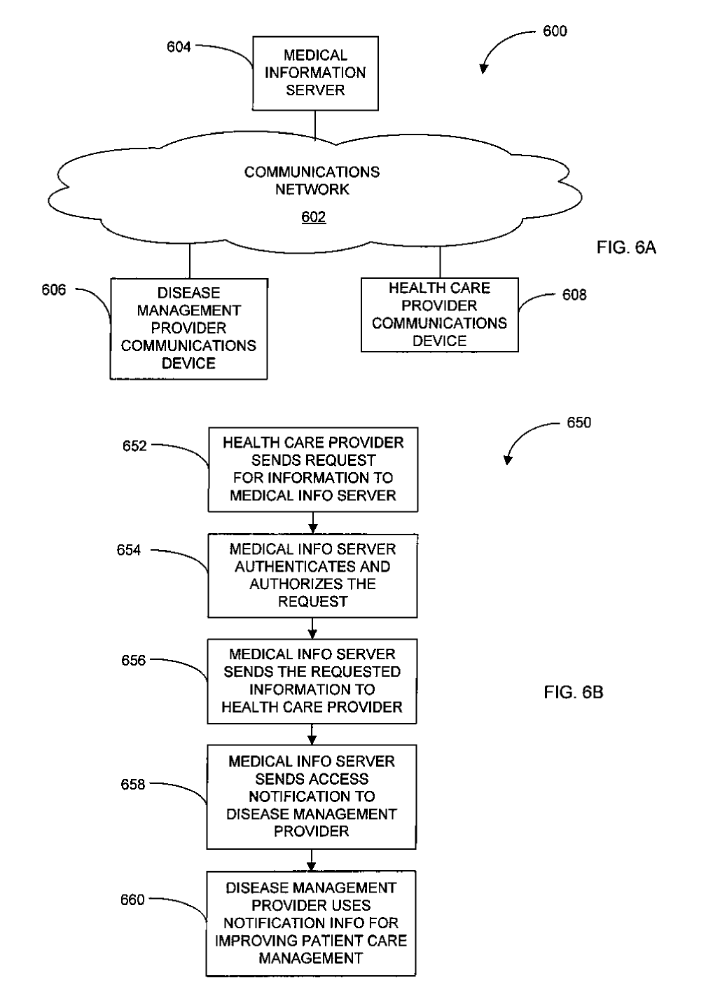

FIG. 6A illustrates a block diagram of another exemplary communications system 600 in accordance with another embodiment of the invention. The communications system 600 comprises a communications network 602, a medical information server 604 coupled to the communications network 602, a disease management provider communications device 606 coupled to the communications network 602, and a health care provider communications device 608 coupled to the communications network 602. The communications system 600 may be configured substantially the same or similar to communications system 100. The communications system 600 is used herein to illustrate another exemplary application of the medical record access notification concepts described herein.

FIG. 6B illustrates a flow diagram of an exemplary method 650 of processing a request for a personal medical record made by a health care provider, and notifying a disease management provider of the access in accordance with another embodiment of the invention. According to the method 650, the health care provider communications device 608 sends a request for information pertaining to a particular personal medical record to the medical information server 604 via the communications network 602 (block 652). As in the previous embodiment, this may be the case where the health care provider is medically treating or about to treat the person to which the medical record pertains, and requires information about the person to better perform the patient care.

In response to the request, the medical information server 604 authenticates and authorizes the request (block 654). Again, this is to ensure that the health care provider is authorized to gain access to the requested medical record. Once the request has been authenticated and authorized, the medical information server 604 sends the requested information to the health care provider communications device 608 via the communications network 602 (block 656). The health care provider uses the information to better provide patient care to the patient and/or for other purposes.

Additionally, the medical information server 604 sends a notification of the access to the personal medical record by the health care provider to the disease management provider communications device 606 via the communications network 602 (block 658). In this example, the disease management provider is identified in the personal medical record as an entity that is to receive notifications of access to the medical record. The disease management provider then uses the notification information for performing patient disease care management and/or for other purposes (block 660). For example, the disease management provider may use the information to customize a plan for better managing the disease (e.g., chronic disease) for the person to which the medical record pertains. Although the operations of the method 650 are described with a particular order, it shall be understood that the method may be implemented in any order to achieve substantially the same results.

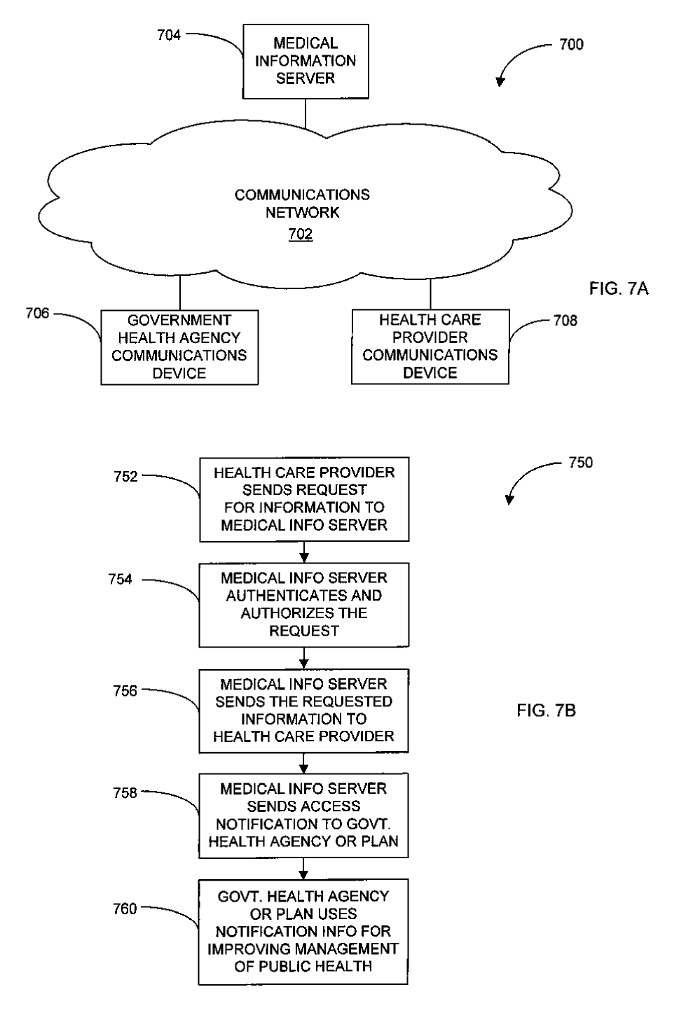

FIG. 7A illustrates a block diagram of another exemplary communications system 700 in accordance with another embodiment of the invention. The communications system 700 comprises a communications network 702, a medical information server 704 coupled to the communications network 702, a government health agency and/or plan (e.g., Medicare, Medicaid, etc.) communications device 706 coupled to the communications network 702, and a health care provider communications device 708 coupled to the communications network 702. The communications system 700 may be configured substantially the same or similar to communications system 100. The communications system 700 is used herein to illustrate another exemplary application of the personal medical record access notification concepts described herein.

FIG. 7B illustrates a flow diagram of an exemplary method 750 of processing a request for a personal medical record made by a health care provider, and notifying a government health agency and/or plan of the access in accordance with another embodiment of the invention. According to the method 750, the health care provider communications device 708 sends a request for information pertaining to a particular personal medical record to the medical information server 704 via the communications network 702 (block 752). Similarly, this may be the case where the health care provider is medically treating or about to treat the person to which the medical record pertains, and requires information about the person to better perform the patient care.

In response to the request, the medical information server 704 authenticates and authorizes the request (block 754). Again, this is to ensure that the health care provider is authorized to gain access to the requested personal medical record. Once the request has been authenticated and authorized, the medical information server 704 sends the requested information to the health care provider communications device 708 via the communications network 702 (block 756). The health care provider uses the information to better provide patient care to the patient and/or for other purposes.

Additionally, the medical information server 704 sends a notification of the access to the personal medical record by the health care provider to the government health agency and/or plan communications device 706 via the communications network 702 (block 758). In this example, the government health plan is identified in the personal medical record as an entity that is to receive notifications of access to the medical record. The government health agency and/or plan then uses the notification information for improving the management of public health and/or for other purposes (block 760). Although the operations of the method 750 are described with a particular order, it shall be understood that the method may be implemented in any order to achieve substantially the same results.

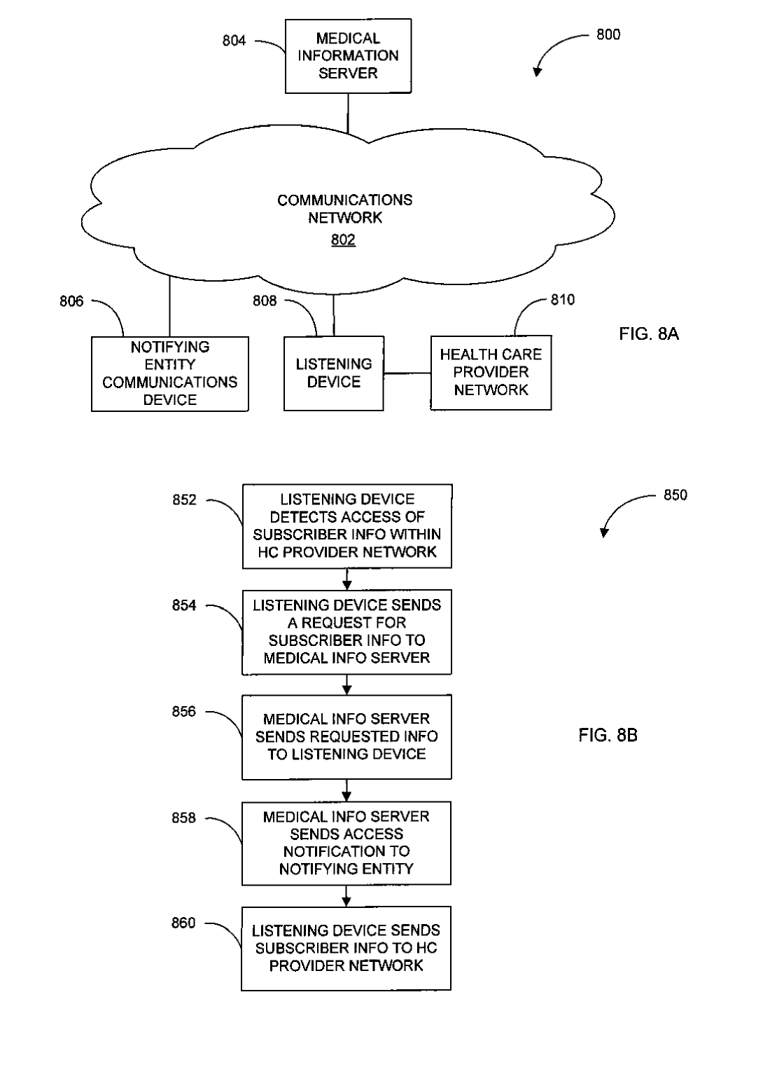

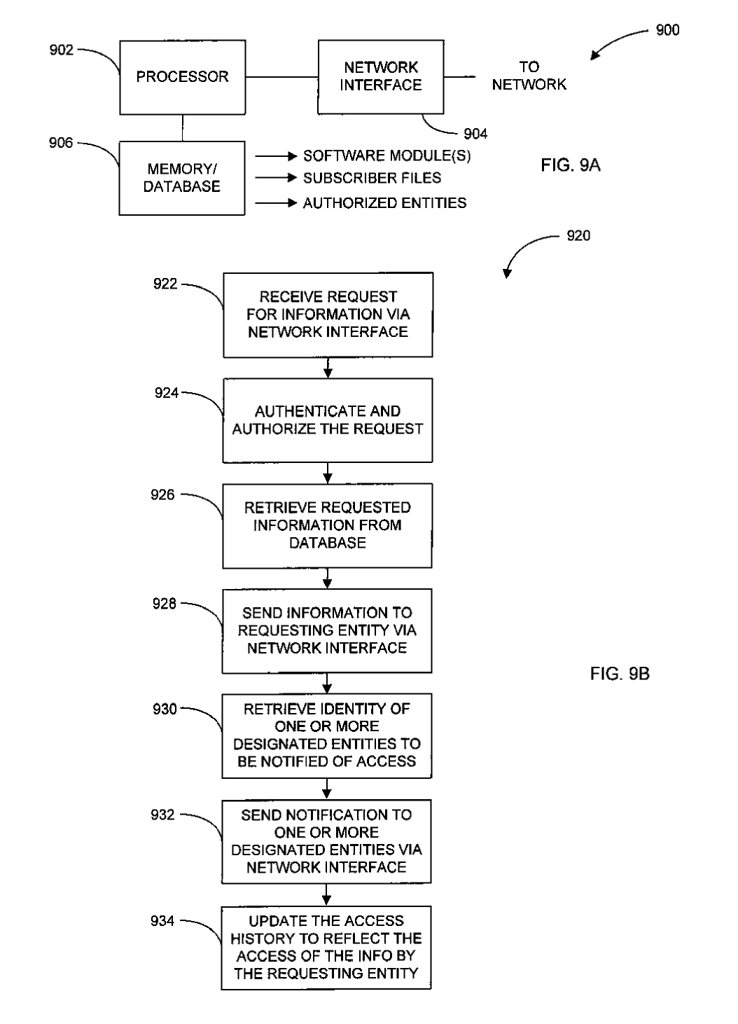

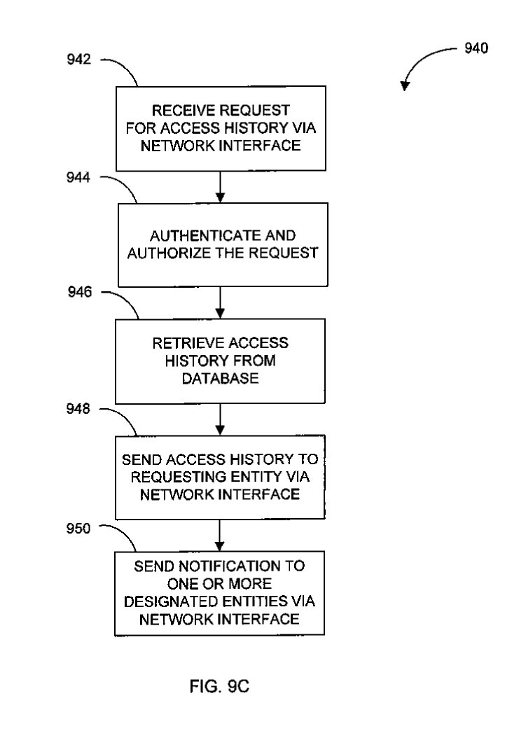

FIG. 8A illustrates a block diagram of another exemplary communications system 800 in accordance with another embodiment of the invention. The communications system 800 comprises a communications network 802, a medical information server 804 coupled to the communications network 802, a notifying entity communications device 806 coupled to the communications network 802, a listening device 808 coupled to the communications network 802, and a health care provider network 810 coupled to the listening device 808. The communications system 800 may be configured similar to communications system 100. The communications system 800 is used herein to illustrate another exemplary application of the processing of personal medical record information described herein.

FIG. 8B illustrates a flow diagram of an exemplary method 850 of processing an automatic request for personal medical records, and notifying designated entities in accordance with another embodiment of the invention. According to the method 850, the listening device 808 monitors internal accesses to patients medical records within the health care provider network 810, and detects whether at least one of those accesses pertains to a personal medical record of the medical information server 804 (block 852). If the listening device 808 detects that one of those accesses pertains to a stored personal medical record, the listening device 808 sends a request for the personal medical record to the medical information server 804 via the communications network 802 (block 854).

In response to the request, the medical information server 804 accesses the personal medical record information and sends it to the listening device 808 via the communications network 802 (block 856). As in the previous embodiments, the medical information server 804 may authenticate and authorize the request prior to sending the information to the listening device 808. The medical information server 804 also sends notification of the access to the medical record to the notifying entity communications device 806 via the communications network 802 (block 858). The listening device 808 also sends the personal medical record information to the health care provider network 810 (block 860). The health care provider may use the information to verify the accuracy of the information it currently has, and update the information based on the information received from the medical information server 804. There may be other uses for the information. Although the operations of the method 850 are described with a particular order, it shall be understood that the method may be implemented in any order to achieve substantially the same results.

FIG. 9A illustrates a block diagram of an exemplary medical information server 900 in accordance with another embodiment of the invention. The medical information server 900 may be one of many exemplary implementations of the medical information servers previously discussed. In particular, the medical information server 902 comprises a processor 902, a network interface 904, and a memory/database 906. The processor 902 performs the various operations of the medical information server 902 as described further herein. The network interface 904 serves to send and receive communications to and from other communications devices. The memory/database 906 stores one or more software module(s) for controlling the processor 902 in performing the various operations, stores a plurality of personal medical records as previously described herein, and stores a list of entities authorized to access personal medical records.

FIG. 9B illustrates a flow diagram of an exemplary method 920 of notifying one or more designated entities of access to a personal medical record performed by the medical information server 900 in accordance with another embodiment of the invention. According to the method 920, the processor 902 receives a request for a personal medical record information via the network interface 904 (block 922). The request includes information identifying the entity that is making the request. In response to the request, the processor 902 authenticates and authorizes the request (block 924). The processor 902 may perform this task by determining whether the requesting entity is on the list of authorized entities stored in the memory/database 906.

Once the processor 902 has authenticated and authorized the request, the processor retrieves the personal medical record information from the memory/database 906 (block 926). It shall be understood that that the memory/database may comprise one or more of the same or distinct memory elements. For example, the memory/database 906 may comprise variants of random access memory (RAM), variants of read only memory (ROM), variants of magnetic hard disk, variants of optical disc, other volatile or non-volatile memory, or any combination thereof. The memory/database 906 need not be all local to the processor 902 but may be remote and accessible via the network interface 904.

Once the processor 902 has accessed the requested personal medical record information, it sends the information to the requesting entity via the network interface 904 (block 928). The processor 902 also examines the personal medical record to ascertain the identity of one or more entities designated to receive notification of the access to the personal medical record (block 930). Once the processor 902 obtains the identity of the one or more notifying entities, it sends the access notification to the one or more notifying entities via the network interface 904 (block 932). The processor 902 further updates the access history to reflect the access of the personal medical record by the requesting entity (block 934). Although the operations of the method 920 are described with a particular order, it shall be understood that the method may be implemented in any order to achieve substantially the same results.

FIG. 9C illustrates a flow diagram of an exemplary method 940 of processing a request for an access history of a personal medical record performed by the medical information server 900 in accordance with another embodiment of the invention. According to the method 940, the processor 902 receives a request for access history of a personal medical record via the network interface 904 (block 942). The request includes information identifying the entity that is making the request. In response to the request, the processor 902 authenticates and authorizes the request (block 944). The processor 902 may perform this task by determining whether the requesting entity is on the list of authorized entities stored in the memory/database 906.

Once the processor 902 has authenticated and authorized the request, the processor retrieves the requested access history from the memory/database 906 (block 946). The processor 902 then sends the access history information to the requesting entity via the network interface 904 (block 948). The processor 902 also sends notification of the access to one or more designated entities via the network interface 904 (block 950). Although the operations of the method 940 are described with a particular order, it shall be understood that the method may be implemented in any order to achieve substantially the same results.

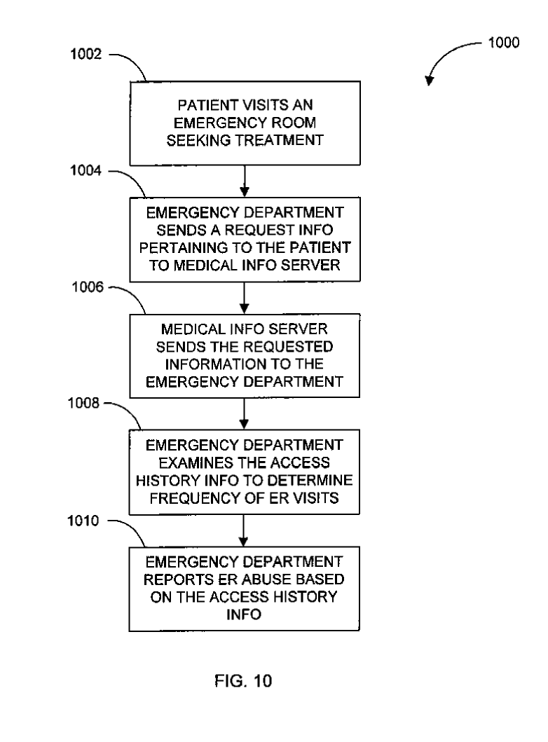

FIG. 10 illustrates a flow diagram of a method 1000 of monitoring the frequency of emergency room (ER) visits by patients in accordance with another embodiment of the invention. Since the personal medical record has information related to the access history including emergency room (ER) visits, health care providers, such as hospitals, may access the information to monitor ER visit abuses by patients. The method 1000 may be implemented in any of the communications systems previously described herein.

In particular, according to the method 1000, a patient visits an emergency room (ER) seeking medical treatment (block 1002). Pursuant to the ER visit, the corresponding emergency department (ED) sends a request for information pertaining to the medical record of the patient to the medical information server (block 1004). After authenticating and authorizing the request, the medical information server sends the information to the ED (block 1006). The information includes the access history which contains data related to ER visits made by the patient. The ED then examines the information to determine the frequency and nature of the ER visits (block 1008). Depending on the determined frequency of the ER visits, the ED may determine that the patient has been abusing ER visits, report the abuses to the patient's health insurer or government or law enforcement agency, and/or deny treatment or the issuance of prescription drugs (block 1010).

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A medical information server adapted to:
receive a request for information pertaining to a personal medical record from a first communications device operated by a first entity;
send the requested information to the first communications device; and
send a notification of access to the personal medical record by the first entity to a second communications device operated by a second entity.

2. The medical information server of claim 1, further adapted to authenticate and authorized the request for the information.

3. The medical information server of claim 1, further adapted to update an access history pertaining to the personal medical record to note the access to the information by the first entity.

4. The medical information server of claim 3, further adapted to:
receive a second request for information pertaining to the access history from a third communications device operated by a third entity; and
send the requested access history information to the third communications device.

5. The medical information server of claim 4, further adapted to send a second notification of access to the access history information by the third entity to the second entity communications device.

6. The medical information server of claim 4, further adapted to authenticate and authorize the second request for the information pertaining to the access history.

7. The medical information server of claim 3, wherein the information pertaining to the access history comprises one or more of the following:
information related to an identity of the first entity;
information related to a location of the first entity;
information related to a method of access by the first entity;
information related to a date of the access to the access history information;
information related to a time of the access to the access history information;
information related to a reason for the access to the access history information.

8. The medical information server of claim 1, wherein the information pertaining to the personal medical record comprises one or more of the following:
information related to personal and demographic of a person to which the personal medical record pertains;
information related to in-case-of emergency;
information related to medical insurance and primary care of the person to which the personal medical record pertains;
information related to a health of the person to which the personal medical record pertains.

9. The medical information server of claim 1, wherein the first entity comprises a health care provider.

10. The medical information server of claim 9, wherein the first entity communications device comprises a listening device adapted to monitor access to patient information within a network operated by the health care provider.

11. The medical information server of claim 1, wherein the second entity comprises a health insurer, a disease management provider, a government health agency or plan, or an in-case-of-emergency contact person.

12. The medical information server of claim 1, wherein the second entity comprises a person to which the personal medical record pertains.

13. A method of processing medical information, comprising:
receiving a request for information pertaining to a personal medical record from a first communications device;
sending the requested information to the first communications device; and
sending a notification of access to the personal medical record by the first communications device to a second communications device.

14. The method of claim 13, further comprising authenticating and authorizing the request for the information.

15. The method of claim 13, further comprising updating an access history pertaining to the personal medical record to note the access to the information by the first communications device.

16. The method of claim 15, further comprising:
receiving a second request for information pertaining to the access history from a third communications device; and
sending the requested access history information to the third communications device.

17. The method of claim 16, further comprising sending a second notification of access to the access history information by the third communications device to the second communications device.

18. The method of claim 16 further comprising authenticating and authorizing the second request for the information pertaining to the access history.

19. The method of claim 13, wherein the second communications device pertains to or is operated by a person to which the personal medical record pertains.

20. A medical information server, comprising:
a database for storing a plurality of personal medical records, and a list of authorized access entities;
a network interface adapted to send and receive communications to and from a network; and
a processor adapted to:
receive a request for information pertaining to a personal medical record from a first communications device by way of the network interface;
access the requested information from the database;
send the requested information to the first communications device by way of the network interface; and
send a notification of the access to the personal medical record information to a second communications device via the network interface.

21. The medical information server of claim 20, wherein the processor is adapted to determine an identity related to the second communications device by accessing the personal medical record.

22. The medical information server of claim 20, wherein the processor is further adapted to authenticate and authorized the request for the information.

23. The medical information server of claim 22, wherein the processor is adapted to authenticate and authorize the request for the information by determining whether the request came from an entity identified in the list of authorized access entities.

24. The medical information server of claim 20, wherein the processor is further adapted to update an access history pertaining to the personal medical record with information related to the sending of the personal medical record information to the first communications device.

25. The medical information server of claim 24, wherein the processor is further adapted to:
receive a second request for information pertaining to the access history from a third communications device by way of the network interface; and
send the requested access history information to the third communications device by way of the network interface.

26. The medical information server of claim 25, wherein the processor is further adapted to send a second notification of the access to the access history information to the second communications device by way of the network interface.

27. The medical information server of claim 25, wherein the processor is further adapted to authenticate and authorize the second request for the information pertaining to the access history.

28. The medical information server of claim 27, wherein the processor is adapted to authenticate and authorize the request for the access history information by determining whether the request came from an entity identified in the list of authorized access entities.

29. The medical information server of claim 20, wherein the second communications device pertains to or is operated by a person to which the personal medical record pertains.

30. A method of determining abuse of emergency room (ER) visits, comprising:
sending a request for information pertaining to a medical record of a patient seeking medical treatment to a medical record server by way of a communications network;
receiving the requested information by way of the communications network, wherein information includes data related to visits to ER made by the patient; and
examining the information to determine whether the patient has abused ER visits.

31. The method of claim 30, further comprising reporting the abuse to another entity if abuse of ER visits has been determined.

32. The method of claim 30, denying medical treatment to the patient if abuse of ER visits has been determined.
